(19) United States
(12) Patent Application Publication
(10) Pub. No.: US 2026/0266100 A1
(43) Pub. Date: Sep. 10, 2026

(54) VEHICLE DOOR HANDLE ASSEMBLY

(71) Applicant: MINEBEA ACCESSSOLUTIONS ITALIA S.P.A., Pianezza (IT)

(72) Inventors: Christophe PERRIN, Pianezza (IT); Bruno VILOTTA, Pianezza (IT)

(73) Assignee: MINEBEA ACCESSSOLUTIONS ITALIA S.P.A., Pianezza (IT)

(21) Appl. No.: 19/561,788

(22) Filed: Mar. 10, 2026

(30) Foreign Application Priority Data
Mar. 10, 2025 (EP) 25162705

(51) Int. Cl. E05B 77/06; E05B 81/90; E05B 85/10

(52) U.S. Cl. CPC E05B 77/06; E05B 81/90; E05B 85/10

(57) ABSTRACT

A vehicle door handle assembly includes an electrical release mechanism including a switch connected to a door latch and a first rotatable lever to rotate between a rest position and an active position wherein the first rotatable lever activates the switch to open the vehicle door. The assembly also includes a backup mechanical release mechanism including a second rotatable lever to rotate between a rest position and an active position in which the second rotatable pulls on a cable linked to the latch to open the door, and an inertial blocking mechanism including an inertial lever to rotate between a rest position and an active position in which the inertial lever blocks the rotation of both the first rotatable lever and the second rotatable lever towards their active position. The inertial lever rotates towards its active position when submitted to an acceleration higher than a predetermined threshold.

### TECHNICAL FIELD

The present invention relates to the field of vehicle door handles to control the opening of vehicle doors and in particular to door handle assemblies comprising an electrical release mechanism.

### BACKGROUND OF THE INVENTION

It is well-known to use inertial mechanism in mechanical vehicle door handle assemblies for blocking a mechanical opening of the door in case of a crash of the vehicle.

Indeed, to comply with the security standards, in particular in case of side crashes, the side vehicle door handles may be equipped with an inertial system. Such inertial system is triggered in case of a side crash of the vehicle and blocks a mechanical release mechanism to prevent from any opening of the door during the crash which could lead to an ejection of a passenger outside the vehicle.

Modern vehicles are equipped with electrical release mechanisms wherein the opening of the door is achieved via an electrical release mechanism generally triggered by an activation of a switch linked to the door latch. The switch may be activated by a pull on the handle according to a first stroke.

In addition to the electrical release mechanism, a mechanical release mechanism is generally used as a backup in case of an outage of the electrical release or in case of an energy shortage. The mechanical release may be achieved by a pull on the handle according to a second stroke larger than the first stroke.

Thus, in order to prevent the opening of the door in case of a crash, it is necessary to block both the electrical release mechanism and the backup mechanical release mechanism.

One way to block the electrical release mechanism is to use additional sensors such as accelerometers to detect the occurrence of a crash and to block electronically the electrical release mechanism. However, such solution may be difficult to implement and may not be reliable.

It is therefore an aim of the present invention to provide a solution that is simple and reliable to block both the electrical release mechanism and the backup mechanical release mechanism of a door handle assembly in case of a crash.

### SUMMARY OF THE INVENTION

The present invention refers to a vehicle door handle assembly comprising:
an electrical release mechanism comprising:
   a switch connected to a door latch,
   a first rotatable lever configured to rotate around a first axis between a rest position and an active position wherein the first rotatable lever activates the switch to trigger an opening of the vehicle door,
a backup mechanical release mechanism comprising a second rotatable lever configured to rotate around a second axis between a rest position and an active position wherein the second rotatable lever is configured to pull on a cable linked to the door latch for opening the vehicle door,
an inertial blocking mechanism comprising an inertial lever configured for rotating around a third axis between a rest position and an active position wherein the inertial lever is configured for blocking the rotation of both the first rotatable lever and the second rotatable lever towards their active position, the inertial lever being configured to rotate towards its active position when submitted to an acceleration higher than a predetermined threshold, in particular in case of a crash of the vehicle.

Such configuration of the vehicle door handle assembly enables blocking both the electrical release mechanism and the backup mechanical release mechanism with a single inertial lever and therefore to prevent the opening of the door in case of a crash.

According to an embodiment of the present invention, one among the inertial lever and the first rotatable lever comprises a protrusion extending towards the other and configured to protrude in a recess of the other when the inertial lever is in its active position to block the rotation of the first rotatable lever.

According to an embodiment of the present invention, the first rotatable lever, the second rotatable lever and the inertial lever are arranged in a housing of the vehicle door handle assembly and the housing comprises a guiding element such as a guiding rib or a guiding pad arranged next to the inertial lever and configured to brush against the inertial lever when the inertial lever is in its active position to prevent or limit a tilt of the inertial lever under the action of the first rotatable lever when the inertial lever is in its active position. The guiding rib is contiguous with the inertial lever.

According to an embodiment of the present invention, the first rotatable lever comprises reinforcing ribs configured to increase the stiffness of the first rotatable lever. The reinforcing ribs may provide an honeycomb structure to the first rotatable lever.

According to an embodiment of the present invention, the first rotatable lever is also configured to rotate towards a backup release position wherein the first rotatable lever drives the rotation of the second rotatable lever towards its active position, the backup release position being associated to an overstroke with respect to the active position.

According to an embodiment of the present invention, the vehicle door handle assembly also comprises a movable handle configured to be displaced between a retracted position wherein the movable handle is flush with an outside door panel and a deployed position wherein the movable handle can be grabbed by a user and wherein the movable handle is linked to the first rotatable lever so that a pull of a first stroke on the movable handle drives the rotation of the first rotatable lever towards its active position.

According to an embodiment of the present invention, the inertial lever is configured for blocking the rotation of the first rotatable lever towards its active position in both the retracted and the deployed position of the movable handle.

According to an embodiment of the present invention, the switch of the electrical release mechanism is located next to the inertial lever to reduce the risk of a contact leading to an activation of the switch between the first rotatable lever and the switch due to a deformation of the first rotatable lever when the first rotatable lever is blocked by the inertial lever.

According to an embodiment of the present invention, the inertial lever comprises an arm extending towards the second rotatable lever when the inertial lever is in its active position to face a part of the second rotatable lever so that the rotation of the second rotatable lever towards its active position is blocked.

According to an embodiment of the present invention, the inertial blocking mechanism is reversible so that when the acceleration undergone by the inertial lever becomes lower than the predetermined threshold, the inertial lever returns to its rest position which releases the first rotatable lever.

According to an embodiment of the present invention, the inertial blocking mechanism comprises a predetermined inertial mass associated with the inertial lever and an elastic element with a predetermined stiffness configured to constrain the inertial lever in its rest position, the inertial mass and the stiffness being chosen to match with the predetermined threshold which triggers to rotation of the inertial lever towards its active position.

According to an embodiment of the present invention, the third axis extends parallel to the first axis and the second axis extends perpendicular to the first axis.

### BRIEF DESCRIPTION OF THE DRAWINGS

FIG. 1 is an outside perspective view of a vehicle door handle assembly according to an embodiment of the present invention with a movable handle in a retracted position;

FIG. 2 is an outside perspective view of the vehicle door handle assembly of FIG. 1 with a movable handle in a deployed position;

FIG. 3 is an inside perspective view of a portion of the vehicle door handle assembly of FIG. 1

FIG. 4 is an outside perspective view of the vehicle door handle assembly of FIG. 1 with a movable handle in an active position;

FIG. 5 is a perspective view of a first rotatable lever according to an embodiment of the present invention;

FIG. 6 is a perspective view of a second rotatable lever according to an embodiment of the present invention;

FIG. 7 is a perspective view of an inertial lever according to an embodiment of the present invention;

FIG. 8 is a perspective view of the inertial lever, the first rotatable lever and the second rotatable lever when the inertial lever is in an active position;

FIG. 9 is an enlarged view of the area where the inertial lever contacts the first rotatable lever when the inertial lever is in an active position;

FIG. 10 is a perspective view of the inertial lever and the first rotatable lever according to another embodiment of the present invention;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments without departing from the scope of the invention defined by the claims.

The present invention refers to a vehicle door handle assembly and in particular a vehicle side door handle assembly.

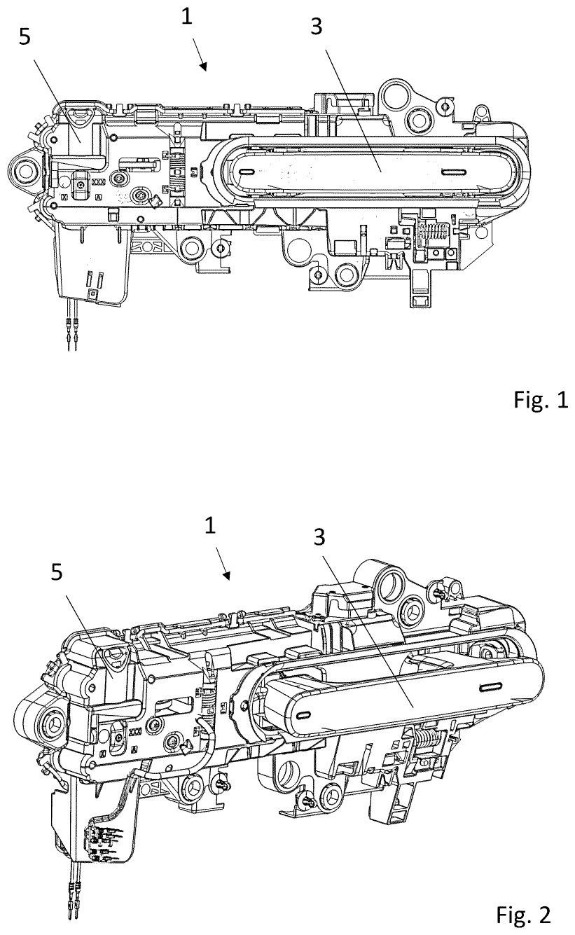

FIG. 1 represents a vehicle door handle assembly 1 according to an embodiment of the present invention. In the present embodiment, the vehicle door handle assembly 1 comprises a movable handle 3 which is configured to move between a retracted position represented in FIG. 1 wherein the movable handle 3 is configured to be flush with the outside door panel to improve the aerodynamic performance of the vehicle and a deployed position represented in FIG. 2 wherein the movable handle 3 can be grabbed by the user to open the door. The movement of the handle 3 from the retracted position to the deployed position may be achieved by an electrical motor upon detection of an authorized user in the vicinity of the door. However, the present invention is not limited to such a movable handle 3 and may be applied to a handle which can be grabbed anytime. The vehicle door handle assembly 1 also comprises a housing 5 configured to be fastened to the door body, for example by screws. FIGS. 1 and 2 represent the side of the vehicle door handle assembly 1 facing the outside of the vehicle when the vehicle door handle assembly 1 is assembled to the vehicle door.

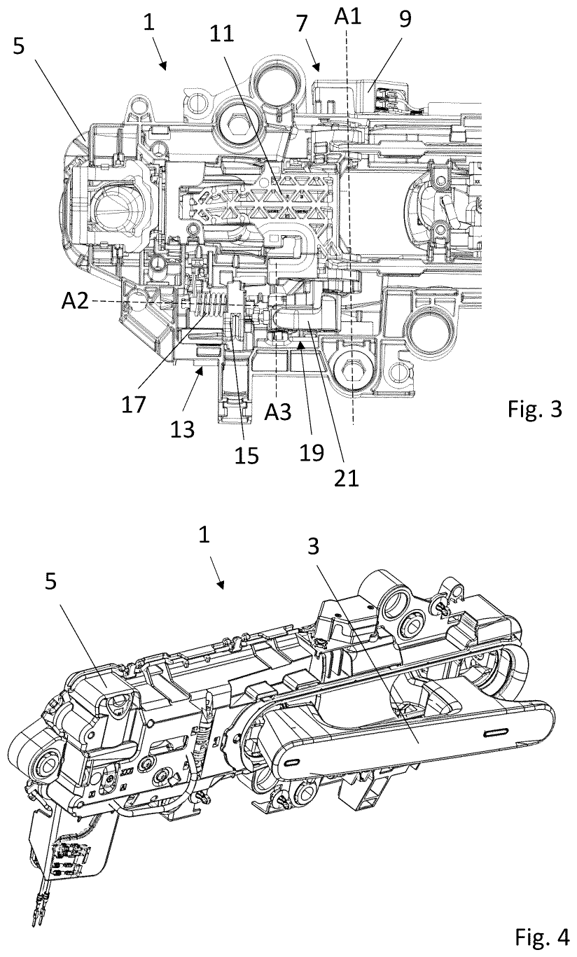

FIG. 3 represents the side of the vehicle door handle assembly 1 facing the inside of the vehicle when the vehicle door handle assembly 1 is assembled to the vehicle door.

### Electrical Release Mechanism 7

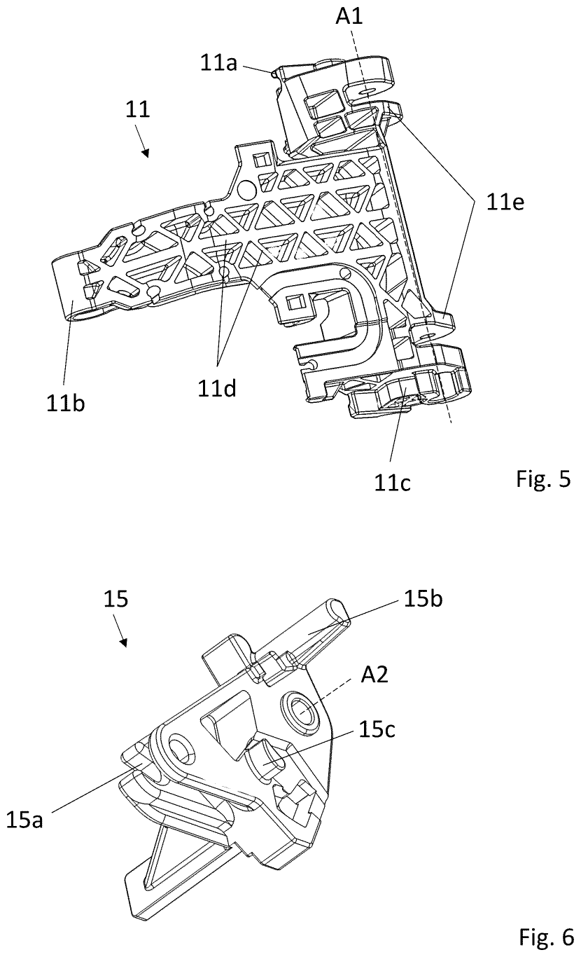

As represented in FIG. 3, the vehicle door handle assembly 1 comprises an electrical release mechanism 7 which comprises a switch 9 connected to a door latch (not represented) which may be remote and located in another portion of the vehicle door. The electrical release mechanism 7 also comprises a first rotatable lever 11 arranged in the housing 5 and visible separately in FIG. 5. The first rotatable lever 11 is configured to rotate around a first axis A1 between a rest position and an active position wherein the first rotatable lever 11 activates the switch 9 either directly or indirectly to trigger an opening of the vehicle door.

The stroke of the first rotatable lever 11 between its rest position and its active position may be reduced, for example between 3° and 20° so that the gap between the pin 11a of the first rotatable lever 11 configured for contacting the switch 9 and the switch 9 in the rest position may also be reduced and comprised between 2 mm and 4 mm.

An end 11b of the first rotatable lever 11 is configured to be linked to the movable handle 3 so that a pull of a first stroke on the movable handle 3 by the user leads to the rotation of the first rotatable lever 11 towards its active position wherein the pin 11a contacts the switch 9 which drives the release of the door latch and the opening of the door. Alternatively, the first rotatable lever 11 may activate the switch 9 indirectly and a further lever (not shown) can be connected to one end of the rotatable lever 11 in a rotationally fixed manner so that the further lever touches the switch 9, which releases the door lock and opens the door.

FIG. 4 represents the movable handle 3 when pulled of the first stroke. An elastic element, such as a spring, may be associated with the first rotatable lever 11 to bring the first rotatable lever 11 back in the rest position when the user releases the movable handle 3.

### Backup Mechanical Release Mechanism 13

The vehicle door handle assembly 1 also comprises a backup mechanical release mechanism 13 which is configured to operate in case of failure of the electrical release mechanism 7 or in case of power shortage preventing the use of the electrical release mechanism 7.

The backup mechanical release mechanism 13 comprises a second rotatable lever 15 arranged in the housing 5 and configured to rotate around a second axis A2 between a rest position and an active position wherein the second rotatable lever 15 is configured to pull on a cable (not represented) linked to the door latch for opening the vehicle door. The second axis A2 may extend perpendicular to the first axis A1. The second rotatable lever 15 is visible separately in FIG. 6. The second rotatable lever 15 comprises a recess 15a configured for receiving a first end of the cable (the second end, opposite to the first end being linked to a remote door latch). The second rotatable lever 15 also comprises an arm 15b configured to interact with the first rotatable lever 11 described previously.

Indeed, the first rotatable lever 11 is also configured to rotate towards a backup release position wherein the first rotatable lever 11 comes in contact with the arm 15b and drives the rotation of the second rotatable lever 15 towards its active position. The backup release position is associated to an overstroke with respect to the stroke associated with the active position of the first rotatable lever 11 represented in FIG. 4. Indeed, in case the door does not open when the user pulls the movable handle 3 of the first stroke associated to the active position of the first rotatable lever 11, the user may pull further to a second stroke larger than the first stroke and associated with an overstroke of the first rotatable lever 11 associated with the backup release position which is beyond its active position. Such overstroke leads the first rotatable lever 11 to come in contact with the arm 15b and to drives the rotation of the second rotatable lever 15 towards its active position which pulls on the cable and releases the door latch mechanically and opens the door. An elastic element, such as a spring 17, may be associated with the second rotatable lever 15 to bring the second rotatable lever 15 back in the rest position when the user releases the movable handle 3.

### Inertial Blocking Mechanism 19

The vehicle door handle assembly 1 also comprises an inertial blocking mechanism 19 which is configured to block both the electrical release mechanism 7 and the backup mechanical release mechanism 13 in case of a crash, in particular a side crash to prevent the opening of the door during the crash.

The inertial blocking mechanism 19 comprises an inertial lever 21 arranged in the housing 5 and configured for rotating around a third axis A3 between a rest position and an active position wherein the inertial lever is configured for blocking the rotation of both the first rotatable lever 11 and the second rotatable lever 15 towards their active position.

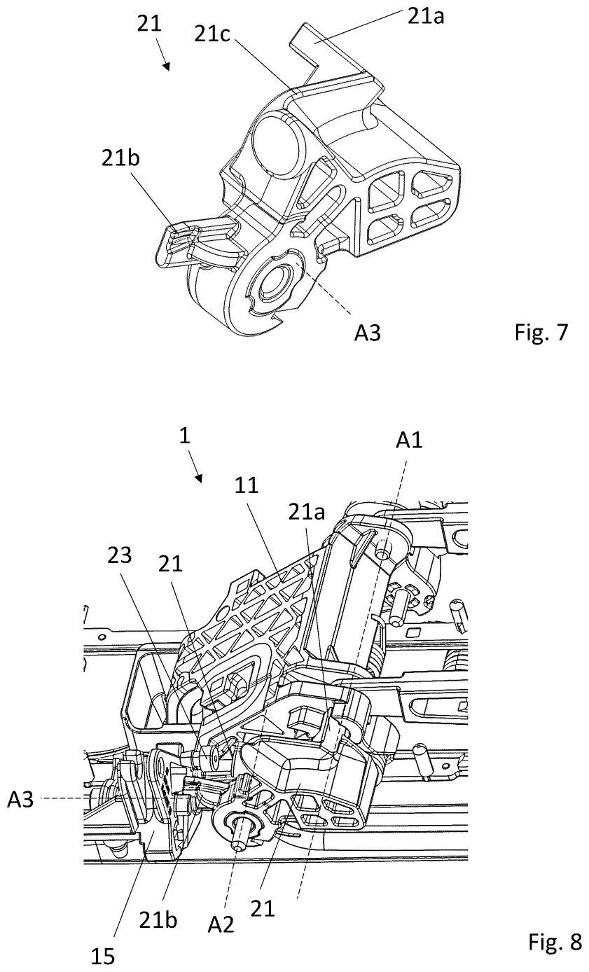

The third axis A3 may extend parallel to the first axis A1. The inertial lever 21 is visible separately in FIG. 7. The inertial lever 21 comprises a protrusion 21a which extends towards the first rotatable lever 11 and is configured to protrude in a recess 11c of the first rotatable lever 11 when the inertial lever 21 is in its active position as represented in FIG. 8.

In case of a movable handle 3 configured to move between a retracted position (flush) and a deployed position, the inertial lever 21 may block the movement of the first rotatable lever 11 and thus the activation of the switch 9 in both the retracted and the deployed position of the handle 3. This prevents the door from opening even when the handle 3 is deployed.

The first rotatable lever 11 may thus have a first and a second recesses 11c into which the protrusion 21a can be engaged or abuts. The protrusion 21a can be engaged in a first recess 11c of the first rotatable lever 11 so that the handle 3 prevents the activation of the switch 9 in the retracted position and the protrusion 21a can be engaged in the second recess 11c of the first rotatable lever 11 so that the handle 3 prevents the activation of the switch 9 in the deployed position.

Alternatively, the protrusion may be arranged on the first rotatable lever 11 and the at least one recess may be arranged in the inertial lever 21.

As a consequence, in the active position of the inertial lever 21, the protrusion 21a abuts the recess 11c so that the inertial lever 21 blocks the rotation of the first rotatable lever 11 towards its active position so that the electrical release mechanism 7 is blocked. Furthermore, as indicated previously, the stroke between the rest position and the active position of the first rotatable lever 11 is reduced. To prevent that a deformation or a tilt of the first rotatable lever 11 or the inertial lever 21 leads to an interaction between the first rotatable lever 11 and the switch 9 leading to an opening of the door, the first rotatable lever 11 may comprise a reinforced structure. In particular, the first rotatable lever 11 may comprise reinforcing ribs 11d to increase the stiffness of the first rotatable lever 11 and may also comprise an oversized hinge 11e (a pair of annular elements configured to receive the shaft associated with the first axis A1 may be used on each side of the hinge 11e) to prevent or limit a tilt of the rotatable lever 11 when its rotation around the first axis A1 is blocked by the inertial lever 21.

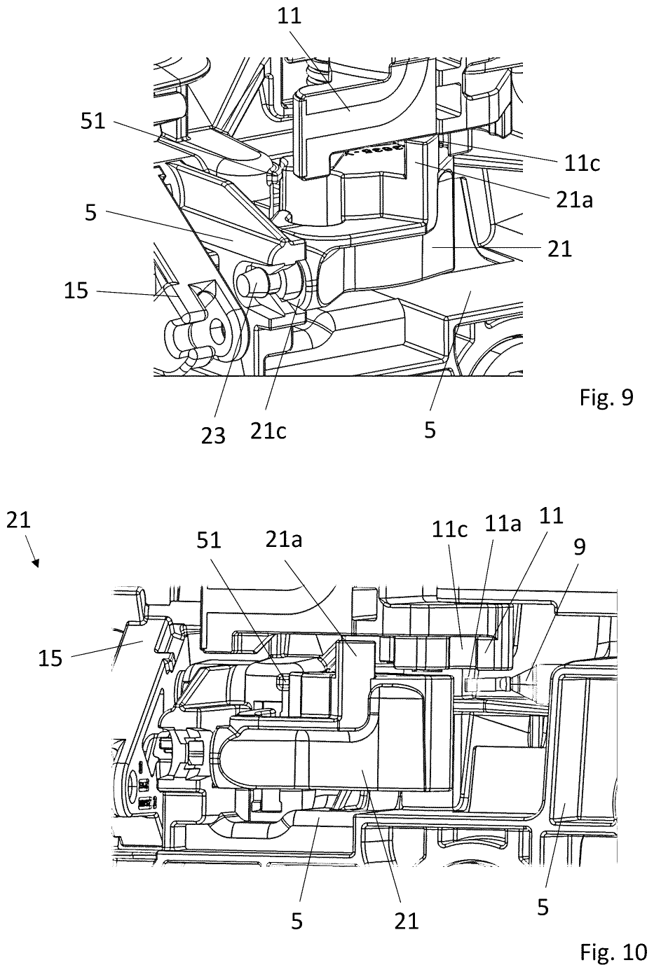

Moreover, in order to prevent or reduce a tilt of the inertial lever 21, and thus the contacting of the switch 9 by the first rotatable lever 11 when the inertial lever 21 is in its active position due to the force applied by the first rotatable lever 11, the housing 5 may comprise a guiding element 51 (visible in FIG. 9) arranged next to the inertial lever 21 and configured to brush against the inertial lever 21 when the inertial lever 21 is in its active position (the gap between the inertial lever 21 and the guiding element 51 when the inertial lever 21 is in its active position is minimized and is for example less than 0.5 mm). The guiding element 51 may be in the form of a rib or a pad and is configured to provide a support or fulcrum to counteract the force applied by the first rotatable lever 11 onto the inertial lever 21 when the inertial lever 21 is in its active position to limit or prevent a tilt of the inertial lever 21.

Thus, the reinforced structure of the first rotatable lever 11 or a guiding element 51 in the housing 5 next to the inertial lever 21 or both allow reducing or preventing a deformation of the inertial lever 21 and the first rotatable lever 11 so that the electrical release mechanism 7 can be reliably blocked by the inertial lever 21 in case of a crash even if the stroke of the first rotatable lever 11 between its rest position and its active position is small.

According to an embodiment of the invention represented in FIG. 10, the switch 9 of the electrical release mechanism 7 is located next to the inertial lever 21 in order to limit the impact of a possible deformation or tilt of the first rotatable lever 11 so that the risk of an activation of the switch 9 during a crash is further reduced. The pin 11a of the first rotatable lever 11 is then located next to the inertial lever, in front of the switch 9.

Besides, the inertial lever 21 also comprises an arm 21b (visible in FIG. 7) extending towards the second rotatable lever 15 when the inertial lever 21 is in its active position to face a part, such as a lug 15c, of the second rotatable lever 15 and blocks the rotation of the second rotatable lever 15. The arm 21b is located in the way of the second rotatable lever 15 towards its active position and prevents therefore the rotation of the second rotatable lever 15 towards its active position. Indeed, even if the first rotatable lever 11 is blocked by the inertial lever 21 in case of a crash, the second rotatable lever 15 may still be displaced towards its active position due to its inertia and the undergone acceleration so that the second rotatable lever 15 also needs to be blocked to prevent a mechanical opening of the door in case of a crash.

The inertial blocking mechanism 19 also comprises an elastic element (not represented) such as a spring, associated with the inertial lever 21 and configured to constrain the inertial lever 21 in its rest position. A damper 23 may be arranged on the housing 5 to prevent or reduce a bouncing of the inertial lever 21 when the inertial lever 21 is brought back to its rest position. The inertial lever 21 may comprise a stop 21c configured to contact the damper 23 in the rest position of the inertial lever 21.

The inertial lever 21 is therefore configured to rotate towards its active position when submitted to an acceleration higher than a predetermined threshold corresponding to a crash, for example an acceleration higher than 10G or 15G. Such predetermined threshold depends on the inertial mass or mass distribution of the inertial lever 21 and the stiffness of the elastic element so that the inertial mass and the stiffness of the elastic element are chosen to match the desired predetermined threshold.

Due to the action of the elastic element, the inertial lever 21 is brought back to its rest position when the acceleration undergone by the inertial lever 21 becomes lower than the predetermined threshold. The damper 23 prevents a bouncing of the inertial lever towards its active position when the undergone acceleration is below the predetermined threshold. The first rotatable lever 11 is then released and can be displaced towards its active position or its backup release position so that the door can be opened by a user after the occurrence of the crash to enable the user to exit the vehicle. Such configuration of the vehicle door handle assembly 1 provides therefore a reversible inertial blocking mechanism 19.

Thus, in case of a crash, the inertial lever 21 undergoes an acceleration higher than the predetermined threshold which drives its rotation towards its active position wherein the inertial lever 21 blocks both the first rotatable lever 11 via the protrusion 21a and the second rotatable lever 15 via the arm 21b. Due to the acceleration undergone by the first rotatable lever 11 and the associated force applied by the first rotatable lever 11 on the inertial lever 21, the inertial lever 21 may be slightly tilted or deformed. Such tilt or deformation leads to the abutment of the inertial lever 21 against the guiding element 51 which contribute to withhold the inertial lever 11 in position and to counter the force applied by the first rotatable lever 11 so that the deformation or tilt of the inertial lever 21 is reduced and the contact between the first rotatable lever 11 and the switch 9 is avoided. Both the electrical release mechanism 7 and the backup mechanical release mechanism 13 are therefore blocked by a single inertial lever 21 so that the number of parts, the bulk and the price of the inertial blocking mechanism 19 are limited which provides, at a reduced cost, a simple and reliable inertial blocking mechanism 19 for a vehicle door handle assembly 1 comprising an electrical release mechanism 7 and a backup mechanical release mechanism 13.

1-13. (canceled)

14. A vehicle door handle assembly, comprising:
an electrical release mechanism comprising:
a switch connected to a door latch, and
a first rotatable lever configured to rotate around a first axis between a rest position and an active position wherein the first rotatable lever activates the switch to trigger an opening of the vehicle door;
a backup mechanical release mechanism comprising a second rotatable lever configured to rotate around a second axis between a rest position and an active position wherein the second rotatable lever is configured to pull on a cable linked to the door latch for opening the vehicle door; and
an inertial blocking mechanism comprising an inertial lever configured to rotate around a third axis between a rest position and an active position wherein the inertial lever is configured to block the rotation of both the first rotatable lever and the second rotatable lever towards their active position, the inertial lever being configured to rotate towards the active position of the inertial lever when submitted to an acceleration higher than a predetermined threshold.

15. The vehicle door handle assembly in accordance with claim 14, wherein one among the inertial lever and the first rotatable lever comprises a protrusion extending towards the other and configured to protrude in a recess of the other when the inertial lever is in the active position of the inertial lever to block the rotation of the first rotatable lever.

16. The vehicle door handle assembly in accordance with claim 15, wherein the first rotatable lever, the second rotatable lever, and the inertial lever are arranged in a housing of the vehicle door handle assembly, and wherein the housing comprises a guiding element arranged next to the inertial lever and configured to brush against the inertial lever when the inertial lever is in the active position of the inertial lever to prevent or limit a tilt of the inertial lever under an action of the first rotatable lever when the inertial lever is in the active position of the inertial lever.

17. The vehicle door handle assembly in accordance with claim 16, wherein the guiding element is a guiding rib or a guiding pad.

18. The vehicle door handle assembly in accordance with claim 14, wherein the first rotatable lever comprises reinforcing ribs configured to increase a stiffness of the first rotatable lever.

19. The vehicle door handle assembly in accordance with claim 14, wherein the first rotatable lever is configured to rotate towards a backup release position wherein the first rotatable lever drives the rotation of the second rotatable lever towards the active position of the second rotatable lever, the backup release position being associated to an overstroke with respect to the active position of first rotatable lever.

20. The vehicle door handle assembly in accordance with claim 14, further comprising a movable handle configured to be displaced between a retracted position wherein the movable handle is flush with an outside door panel and a deployed position wherein the movable handle can be grabbed by a user, wherein the movable handle is linked to the first rotatable lever so that a pull of a first stroke on the movable handle drives the rotation of the first rotatable lever towards the active position of the first rotatable lever.

21. The vehicle door handle assembly in accordance with claim 20, wherein the inertial lever is configured to block the rotation of the first rotatable lever towards the active position of the first rotatable lever in both the retracted and the deployed position of the movable handle.

22. The vehicle door handle assembly in accordance with claim 14, wherein the switch of the electrical release mechanism is located next to the inertial lever to reduce a risk of a contact between the first rotatable lever and the switch due to a deformation of the first rotatable lever when the first rotatable lever is blocked by the inertial lever.

23. The vehicle door handle assembly in accordance with claim 14, wherein the inertial lever comprises an arm extending towards the second rotatable lever when the inertial lever is in the active position of the inertial lever to face a part of the second rotatable lever so that the rotation of the second rotatable lever towards the active position of the second rotatable lever is blocked.

24. The vehicle door handle assembly in accordance with claim 14, wherein the inertial blocking mechanism is reversible so that when the acceleration undergone by the inertial lever becomes lower than the predetermined threshold, the inertial lever returns to the rest position of the inertial lever which releases the first rotatable lever.

25. The vehicle door handle assembly in accordance with claim 14, wherein the inertial blocking mechanism comprises a predetermined inertial mass associated with the inertial lever and an elastic element with a predetermined stiffness configured to constrain the inertial lever in the rest position of the inertial lever, the inertial mass and the stiffness being chosen to match with the predetermined threshold which triggers the rotation of the inertial lever towards the active position of the inertial lever.

26. The vehicle door handle assembly in accordance with claim 14, wherein the third axis extends parallel to the first axis and the second axis extends perpendicular to the first axis.
